(19) United States
(12) Patent Application Publication
(10) Pub. No.: US 2016/0049787 A1
(43) Pub. Date: Feb. 18, 2016

(54) POWER SOCKET APPARATUS WITH SHORT DISTANCE COMMUNICATION FUNCTION

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 14/462,041

(22) Filed: Aug. 18, 2014

(51) Int. Cl. H02J 3/00; H01R 13/66; G06K 19/07

(52) U.S. Cl. CPC H02J 3/00; G06K 19/0701; G06K 19/0723; H01R 13/6691

(57) ABSTRACT

A power socket apparatus with short distance communication functions includes a plurality of power sockets, a plurality of antenna modules, a plurality of short distance communication readers-writers, a microcontroller and a power supply circuit. The short distance communication reader-writer receives a data of an electronic apparatus through the antenna module when a power plug is plugged into the power socket, wherein the data of the electronic apparatus is stored in an electronic tag. The short distance communication reader-writer sends the data of the electronic apparatus to the microcontroller. The microcontroller is configured to control the power supply circuit to output a power to the power socket according to the data of the electronic apparatus, so that the electronic apparatus receives the power through the power plug and the power socket.

### BACKGROUND OF THE INVENTION

1. Field of the Invention

The present invention relates to a power socket apparatus, and especially relates to a power socket apparatus with short distance communication functions.

2. Description of the Related Art

Radio frequency identification (RFID) is a technology for retrieving data from radio frequency identification tags. Radio frequency identification tags can be read on a short distance from a radio frequency identification reader.

Near field communication (NFC) is a high frequency wireless communication method applied in wireless transmission devices that are spaced from each other within about a distance of 10 cm. The near field communication technology is an extension of the radio frequency identification technology.

However, it is a pity that currently there is no product which combines the power socket with RFID or NFC.

### SUMMARY OF THE INVENTION

In order to solve the above-mentioned problems, an object of the present invention is to provide a power socket apparatus with short distance communication functions.

In order to achieve the object of the present invention mentioned above, the power socket apparatus is applied to a plurality of electronic apparatuses and a plurality of power line apparatuses. The power line apparatus is electrically connected to the electronic apparatus. The electronic apparatus comprises a temperature detector. The power line apparatus comprises a power plug and an electronic tag. The temperature detector detects a temperature of the electronic apparatus and informs the electronic tag of the temperature of the electronic apparatus. The electronic tag is arranged inside the power plug. The electronic tag stores a data of the electronic apparatus. The power socket apparatus comprises a plurality of power sockets, a plurality of antenna modules, a plurality of short distance communication readers-writers, a microcontroller and a power supply circuit. The antenna modules are arranged inside the power sockets. The short distance communication readers-writers are electrically connected to the antenna modules. The microcontroller is electrically connected to the short distance communication readers-writers. The power supply circuit is electrically connected to the microcontroller and the power sockets. The short distance communication reader-writer receives the data of the electronic apparatus through the antenna module when the power plug is plugged into the power socket, wherein the data of the electronic apparatus is stored in the electronic tag. The short distance communication reader-writer sends the data of the electronic apparatus to the microcontroller. The microcontroller is configured to control the power supply circuit to output a power to the power socket according to the data of the electronic apparatus, so that the electronic apparatus receives the power through the power plug and the power socket.

Moreover, the power socket apparatus further comprises a plurality of antenna connectors electrically connected to the antenna modules and the short distance communication readers-writers.

Moreover, the power socket comprises an accommodating space defined inside the power socket. The antenna module is arranged inside the accommodating space.

Moreover, the short distance communication reader-writer is a radio frequency identification reader-writer or a near field communication reader-writer.

Moreover, the antenna module comprises a printed circuit board antenna arranged inside the accommodating space.

Moreover, the power socket apparatus further comprises an extended printed circuit board electrically connected to the printed circuit board antenna.

Moreover, the power socket apparatus further comprises a connector arranged on the extended printed circuit board and electrically connected to the extended printed circuit board and the printed circuit board antenna.

Moreover, the antenna module comprises a ferrite rod arranged inside the accommodating space.

Moreover, the antenna module further comprises a coil wrapped around the ferrite rod.

Moreover, the antenna module comprises a copper wire antenna arranged inside the accommodating space.

The advantage of the present invention is to combine the antenna module and the power socket.

### BRIEF DESCRIPTION OF DRAWING

FIG. 1 shows a partial perspective drawing viewing from the top of the first embodiment of the power socket apparatus of the present invention.

FIG. 2 shows a partial perspective drawing viewing from the top of the second embodiment of the power socket apparatus of the present invention.

FIG. 3 shows a partial perspective drawing viewing from the top of the third embodiment of the power socket apparatus of the present invention.

FIG. 4 shows a partial perspective drawing viewing from the top of the fourth embodiment of the power socket apparatus of the present invention.

FIG. 5 shows a block diagram of the power socket apparatus of the present invention.

### DETAILED DESCRIPTION OF THE INVENTION

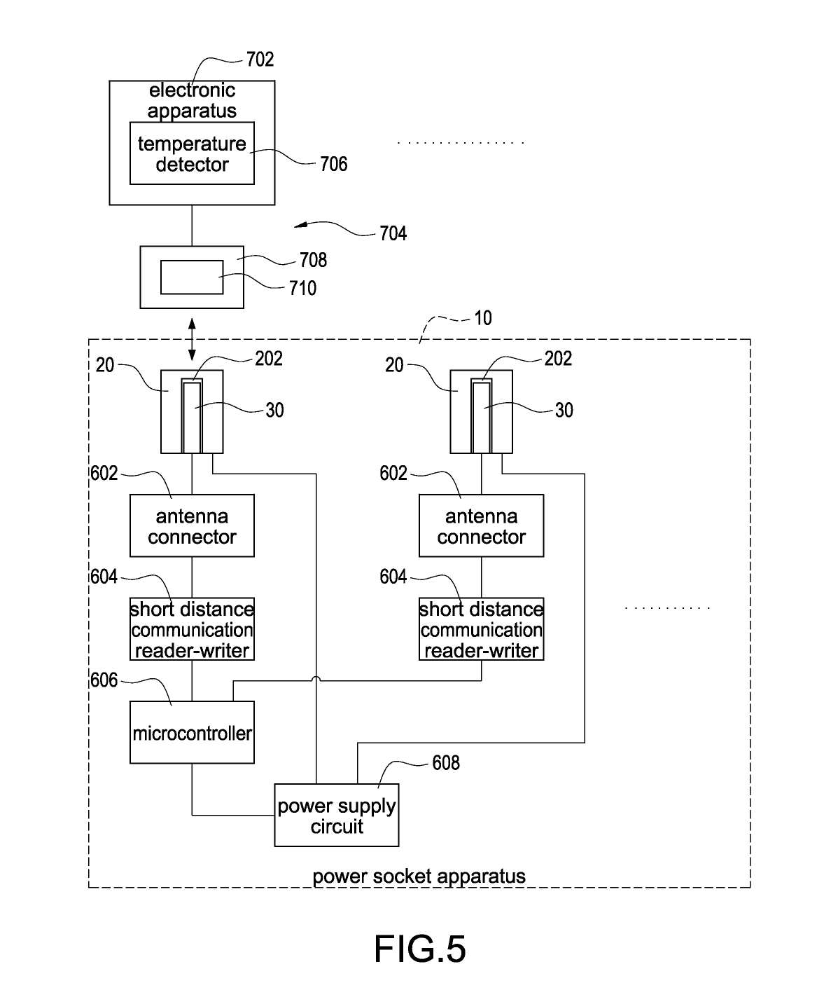

FIG. 5 shows a block diagram of the power socket apparatus of the present invention. A power socket apparatus 10 with short distance communication functions is applied to a plurality of electronic apparatuses 702 and a plurality of power line apparatuses 704. The power line apparatus 704 is electrically connected to the electronic apparatus 702. The electronic apparatus 702 comprises a temperature detector 706. The power line apparatus 704 comprises a power plug 708 and an electronic tag 710.

The temperature detector 706 detects a temperature of the electronic apparatus 702 and informs the electronic tag 710 of the temperature of the electronic apparatus 702. The electronic tag 710 is arranged inside the power plug 708. The electronic tag 710 stores a data (for example, an identification code, temperature data, power consumption value, maintenance record of the electronic apparatus 702) of the electronic apparatus 702.

The power socket apparatus 10 comprises a plurality of power sockets 20, a plurality of antenna modules 30, a plurality of short distance communication readers-writers 604, a microcontroller 606, a power supply circuit 608 and a plurality of antenna connectors 602. The power socket 20 comprises an accommodating space 202.

The antenna modules 30 are arranged inside the power sockets 20. The short distance communication readers-writers 604 are electrically connected to the antenna modules 30. The microcontroller 606 is electrically connected to the short distance communication readers-writers 604. The power supply circuit 608 is electrically connected to the microcontroller 606 and the power sockets 20. The antenna connectors 602 are electrically connected to the antenna modules 30 and the short distance communication readers-writers 604. The accommodating space 202 is defined inside the power socket 20. The antenna module 30 is arranged inside the accommodating space 202.

The short distance communication reader-writer 604 receives the data of the electronic apparatus 702 through the antenna module 30 when the power plug 708 is plugged into the power socket 20, wherein the data of the electronic apparatus 702 is stored in the electronic tag 710. The short distance communication reader-writer 604 sends the data of the electronic apparatus 702 to the microcontroller 606. The microcontroller 606 is configured to control the power supply circuit 608 to output a power to the power socket 20 according to the data of the electronic apparatus 702, so that the electronic apparatus 702 receives the power through the power plug 708 and the power socket 20. The microcontroller 606 receives the data of the electronic device 702 sent from the short distance communication readers-writers 604 in order, thus avoiding mistakes.

The electronic device 702 is, for example but not limited to, a server. The electronic tag 710 is, for example but not limited to, a radio frequency identification tag or a near field communication tag. The electronic tag 710 is waterproof.

The antenna module 30 is, for example but not limited to, a radio frequency identification antenna or a near field communication antenna. The antenna connector 602 is, for example but not limited to, an I-PEX connector or an SMA connector. The short distance communication reader-writer 604 is, for example but not limited to, a radio frequency identification reader-writer or a near field communication reader-writer.

An interface (not shown in FIG. 5) arranged between the microcontroller 606 and the short distance communication reader-writer 604 is, for example but not limited to, a universal asynchronous receiver/transmitter, a serial peripheral interface, an inter integrated circuit bus or a universal serial bus.

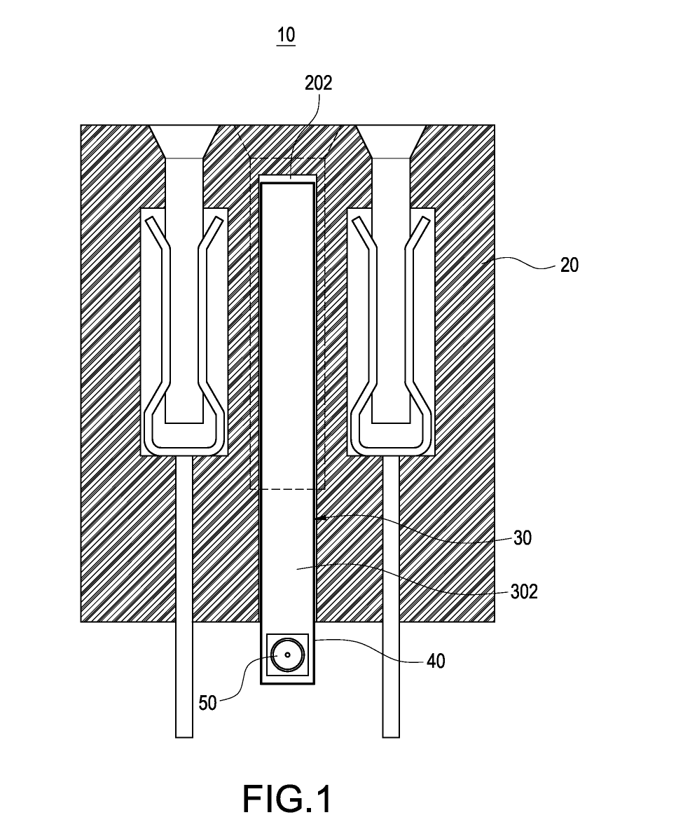

FIG. 1 shows a partial perspective drawing viewing from the top of the first embodiment of the power socket apparatus of the present invention. A power socket apparatus 10 with short distance communication functions comprises a power socket 20, an antenna module 30, an extended printed circuit board 40 and a connector 50. The power socket 20 comprises an accommodating space 202. The antenna module 30 comprises a printed circuit board antenna 302.

The accommodating space 202 is defined inside the power socket 20. The antenna module 30 is arranged inside the accommodating space 202. The printed circuit board antenna 302 is arranged inside the accommodating space 202. The extended printed circuit board 40 is electrically connected to the printed circuit board antenna 302. The connector 50 is arranged on the extended printed circuit board 40 and electrically connected to the extended printed circuit board 40 and the printed circuit board antenna 302.

The antenna module 30 is, for example but not limited to, a radio frequency identification antenna or a near field communication antenna. The connector 50 is, for example but not limited to, an I-PEX connector or an SMA connector. A hole of the accommodating space 202 can be sealed with glues.

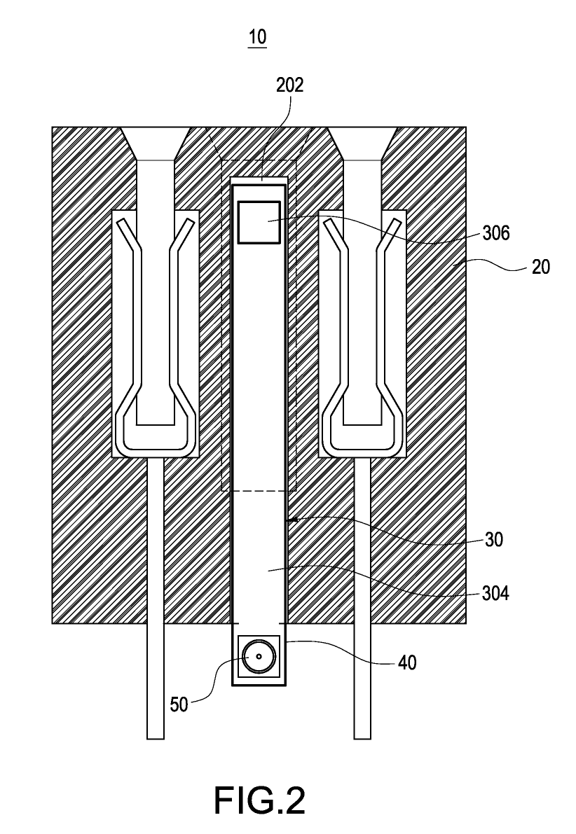

FIG. 2 shows a partial perspective drawing viewing from the top of the second embodiment of the power socket apparatus of the present invention. A power socket apparatus 10 with short distance communication functions comprises a power socket 20, an antenna module 30, an extended printed circuit board 40 and a connector 50. The power socket 20 comprises an accommodating space 202. The antenna module 30 comprises an internal printed circuit board 304 and an inductor antenna 306.

The accommodating space 202 is defined inside the power socket 20. The antenna module 30 is arranged inside the accommodating space 202. The internal printed circuit board antenna 304 is arranged inside the accommodating space 202. The inductor antenna 306 is arranged on the internal printed circuit board 304 and electrically connected to the internal printed circuit board 304. The extended printed circuit board 40 is electrically connected to the internal printed circuit board antenna 304 and the inductor antenna 306. The connector 50 is arranged on the extended printed circuit board 40 and electrically connected to the extended printed circuit board 40, the internal printed circuit board antenna 304 and the inductor antenna 306.

The antenna module 30 is, for example but not limited to, a radio frequency identification antenna or a near field communication antenna. The connector 50 is, for example but not limited to, an I-PEX connector or an SMA connector. A hole of the accommodating space 202 can be sealed with glues.

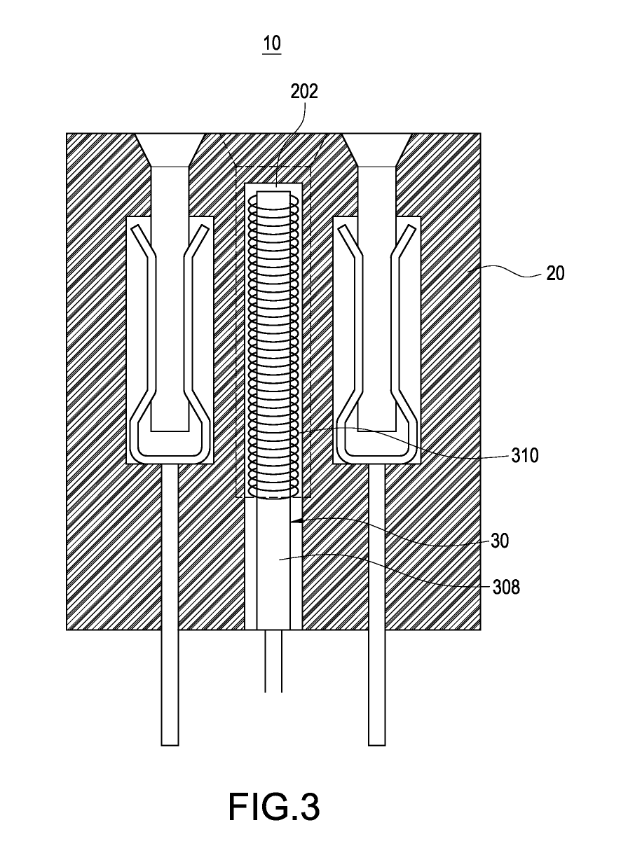

FIG. 3 shows a partial perspective drawing viewing from the top of the third embodiment of the power socket apparatus of the present invention. A power socket apparatus 10 with short distance communication functions comprises a power socket 20 and an antenna module 30. The power socket 20 comprises an accommodating space 202. The antenna module 30 comprises a ferrite rod 308 and a coil 310.

The accommodating space 202 is defined inside the power socket 20. The antenna module 30 is arranged inside the accommodating space 202. The ferrite rod 308 is arranged inside the accommodating space 202. The coil 310 is wrapped around the ferrite rod 308.

The antenna module 30 is, for example but not limited to, a radio frequency identification antenna or a near field communication antenna. A hole of the accommodating space 202 can be sealed with glues.

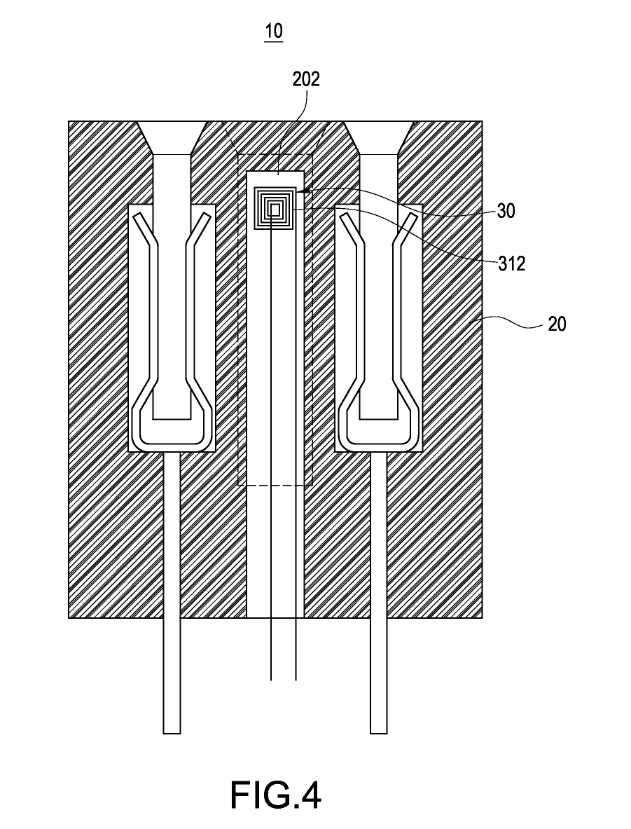

FIG. 4 shows a partial perspective drawing viewing from the top of the fourth embodiment of the power socket apparatus of the present invention. A power socket apparatus 10 with short distance communication functions comprises a power socket 20 and an antenna module 30. The power socket 20 comprises an accommodating space 202. The antenna module 30 comprises a copper wire antenna 312.

The accommodating space 202 is defined inside the power socket 20. The antenna module 30 is arranged inside the accommodating space 202. The copper wire antenna 312 is arranged inside the accommodating space 202.

The antenna module 30 is, for example but not limited to, a radio frequency identification antenna or a near field communication antenna. A hole of the accommodating space 202 can be sealed with glues.

The advantage of the present invention is to combine the antenna module 30 and the power socket 20. Moreover:

1. The microcontroller 606 is configured to check whether the identification code of the electronic device 702 is correct or not. When the identification code of the electronic device 702 is correct, the microcontroller 606 is configured to control the power supply circuit 608 to output the power to the power socket 20, so that the electronic device 702 receives the power through the power plug 708 and the power socket 20. When the identification code of the electronic device 702 is incorrect, the microcontroller 606 is configured to control the power supply circuit 608 to stop outputting the power to the power socket 20, so that the electronic device 702 does not receive the power.

2. The microcontroller 606 receives the temperature data of all of the electronic devices 702 for further temperature controlling.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power socket apparatus with short distance communication functions, the power socket apparatus applied to a plurality of electronic apparatuses and a plurality of power line apparatuses, the power line apparatus electrically connected to the electronic apparatus, the electronic apparatus comprising a temperature detector, the power line apparatus comprising a power plug and an electronic tag, the temperature detector detecting a temperature of the electronic apparatus and informing the electronic tag of the temperature of the electronic apparatus, the electronic tag arranged inside the power plug, the electronic tag storing a data of the electronic apparatus, the power socket apparatus comprising:
a plurality of power sockets;
a plurality of antenna modules arranged inside the power sockets;
a plurality of short distance communication readers-writers electrically connected to the antenna modules;
a microcontroller electrically connected to the short distance communication readers-writers; and
a power supply circuit electrically connected to the microcontroller and the power sockets,
wherein the short distance communication reader-writer receives the data of the electronic apparatus through the antenna module when the power plug is plugged into the power socket; the data of the electronic apparatus is stored in the electronic tag; the short distance communication reader-writer sends the data of the electronic apparatus to the microcontroller; the microcontroller is configured to control the power supply circuit to output a power to the power socket according to the data of the electronic apparatus, so that the electronic apparatus receives the power through the power plug and the power socket.

2. The power socket apparatus in claim 1, further comprising a plurality of antenna connectors electrically connected to the antenna modules and the short distance communication readers-writers.

3. The power socket apparatus in claim 2, wherein the power socket comprises an accommodating space defined inside the power socket; the antenna module is arranged inside the accommodating space.

4. The power socket apparatus in claim 3, wherein the short distance communication reader-writer is a radio frequency identification reader-writer or a near field communication reader-writer.

5. The power socket apparatus in claim 3, wherein the antenna module comprises a printed circuit board antenna arranged inside the accommodating space.

6. The power socket apparatus in claim 5, further comprising an extended printed circuit board electrically connected to the printed circuit board antenna.

7. The power socket apparatus in claim 6, further comprising a connector arranged on the extended printed circuit board and electrically connected to the extended printed circuit board and the printed circuit board antenna.

8. The power socket apparatus in claim 3, wherein the antenna module comprises a ferrite rod arranged inside the accommodating space.

9. The power socket apparatus in claim 8, wherein the antenna module further comprises a coil wrapped around the ferrite rod.

10. The power socket apparatus in claim 3, wherein the antenna module comprises a copper wire antenna arranged inside the accommodating space.
